(19) United States
(12) Patent Application Publication
(10) Pub. No.: US 2016/0314312 A1
(43) Pub. Date: Oct. 27, 2016

(54) METHOD FOR CAUSING OPERATING SYSTEM TO HAVE IMMUNE FUNCTION

(71) Applicant: Masao ASADA, Kanagawa (JP)

(72) Inventor: Masao ASADA, Kanagawa (JP)

(21) Appl. No.: 15/103,525

(22) PCT Filed: Jan. 16, 2014
(86) PCT No.: PCT/JP2014/050660

§ 371 Date: Jun. 10, 2016

(51) Int. Cl. G06F 21/62; G06F 21/55

(52) U.S. Cl. CPC G06F 21/6218; G06F 21/55; G06F 2221/034

(57) ABSTRACT

Process information is caused to have an input source and access rights to resources, and by identifying from what input source a process has arisen and from what input source a command request originates, foreign process and normal processes are distinguished. By limiting access to system resources from foreign processes, the system is protected.

### TECHNICAL FIELD

The present invention relates to a method for causing an operating system (OS) to have an immune function.

### BACKGROUND OF THE TECHNOLOGY

Heretofore, processes are executed without distinction of foreign processes and normal processes. Commands are also executed without distinction foreign commands and normal commands.

### documents for prior art

### Patent Literature

Patent Literature No. 1: None

In the operating system and the service programs, if there is no distinction of foreign treatments and normal treatments, it is impossible to have immune function.

### SUMMARY OF THE INVENTION

### Problem to be Solved by the Invention

The present invention is provided for protecting systems from foreign treatments (virus, hacking or the like) by giving an immune function (a function for restricting accesses of a system resource corresponding to foreign information of the processes) to the operating system.

### Means for Solving the Problem

A kernel of the operating system (OS) has foreignness level control information setting a foreignness level to an input source of data in order to recognize information of the foreignness level. It is a more important resource so that the foreignness level is lower.

The process has information of
resource access right
foreignness level

as foreign information in process information.

The resource access right is an access right to the resource that the foreignness level is assigned.

The foreignness level of the process information is a foreignness level of an input source used at producing of the process or of an input source of input data.

The kernel of the operating system has resource access information for assigning the resource access right to the process at producing of the process.

The resource access information is information that is constituted of an objective (program or the like) and a resource access right assigning to the objective.

The foreignness level of the process information transits from a low level to a high level thereof, but does not transit from the high level to the low level thereof conversely.

The kernel of the operating system has a function (an immune function) restricting accesses to a system resource (memory medium or the like) by foreign information of the process.

### Effects of the Invention

Because a process with foreignness level 0 transits to a process with foreignness level 2 when it receives command requests from an external internet, accesses to resources with low foreignness levels (foreignness level 0, foreignness level 1) are restricted, so that a leakage of classified information can be prevented. Besides, there is no case that a process with foreignness level 0 is restricted because foreignness level does not transit in command requests from the special lines (devices with foreignness level 0).

Execution of a program being in foreignness level 2 of a universal serial bus (USB) or the like is recognized as a program with foreignness level 2, so that accesses to a resource with foreignness level 2 are restricted, as a result, it is prevented for the system to be broken even if it is a program with harmful intent.

### BRIEF DESCRIPTION OF THE DRAWING

FIG. 1 is a diagrammatic illustration showing a method for giving an immune function to the operating system according to the working mode of the present invention.

### MODE FOR CARRYING OUT THE INVENTION

The present invention is constituted of foreignness level control information for recognizing foreignness level in data of an input source, resource access information for determining resource access rights of the process, and the process having foreignness information, and a method for achieving an immune function (a function for restricting accesses to the system resource) by the foreignness information of the process.

Representing the foreignness level control information by using the embodiment;
Foreignness level control information:

| (Input resource) | (Foreignness level) |
|---|---|
| Keyboard | Foreignness level 0 |
| Dedicated line | Foreignness level 0 |
| In-company intranet LAN card | Foreignness level 1 |
| External interne LAN card | Foreignness level 2 |
| C: drive | Foreignness level 0 |
| D:drive | Foreignness level 1 |
| D:/temp/ | Foreignness level 9 |
| Other than those above | Foreignness level 2 |

Representing the resource access information by using the embodiment;

Resource access information:

| (Objective) | (Resource access right) |
|---|---|
| Program A | 030 |
| Program B | 111 |
| Process with foreignness level 9 | 011 |
| Other than those above | 033 |

Constitution of the resource access rights:

(1) (2) (3)

(1): the access right to the resource with lower foreignness level than the foreignness level of the process.
(2): the access right to the resource with the same foreignness level as the foreignness level of the process.
(3): the access right to the resource with higher foreignness level than the foreignness level of the process.
No. 2 of the constitution of the resource access rights.

(4) (5) (6)

(4): the access right to the resource with foreignness level 0
(5): the access right to the resource with foreignness level 1
(6): the access right to the resource with foreignness level 2

The content of the number of the resource access right:

0: Access denied
1: Reading permitted
2: Writing permitted
3: Reading and writing permitted
The meaning of the resource access right:
030: Access permitted only to the resource having the same foreignness level
111: Reading permitted to all of resource
033: Access permitted to the resource having the same foreignness level and the high foreignness level

### Working Embodiment

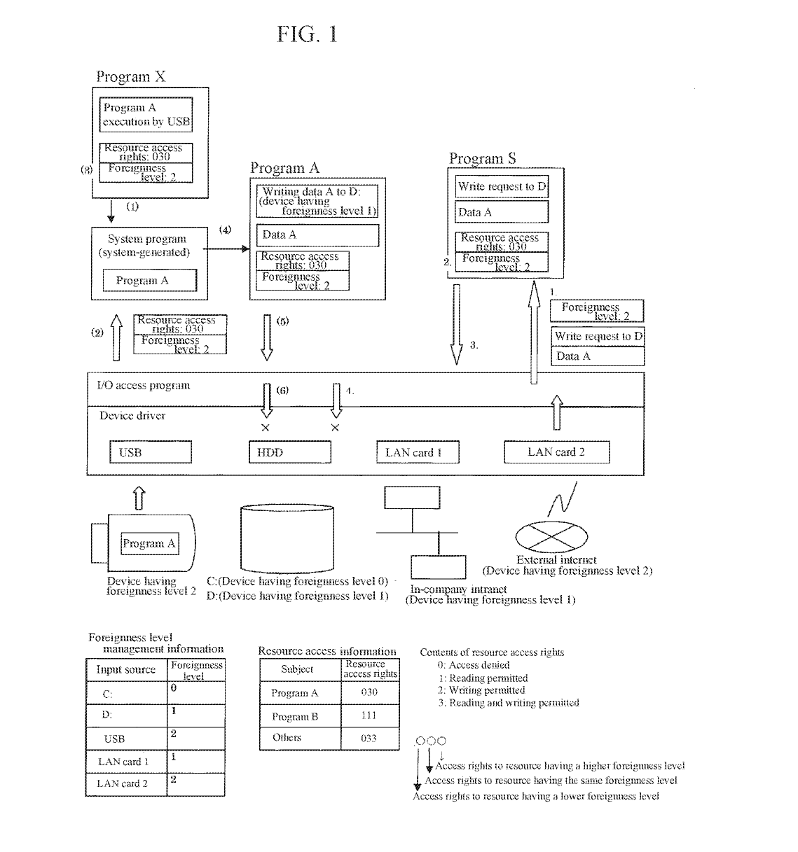

Hereinafter, the embodiment according to the present invention is explained by using FIG. 1.

The case that the program A existing in the USB card is executed is explained by using FIG. 1.

(1) The program X requests the system program to produce the process of the program A existing in the USB card.
(2) The system program requests reading of the program A from the USB card (foreignness level 2) to an I/O access program.
(3) The I/O access program sets “2” to a foreignness level of the program X due to the resource access information.
(4) The system program produces a new process and sets “2” to a foreignness level of the produced process and “030” (access permitted only to the resource having the same foreignness level) to the resource access right.
(5) The program A requests writing of data A to a D drive (a resource with foreignness level 1) to the I/O access program.
(6) The I/O access program denies the request for writing of the data A to the D drive due to the foreignness level and the resource access right of the program A.

Next, the case that a service program receives commands from the external internet is explained by using FIG. 1.

1. A program S reads data from the I/O access program.
2. The I/O access program sets a foreignness level 2 of an input source (a LAN card 2) of the data to a foreignness level of of the program S.
3. The program S requests writing of the data A to the D drive to the I/O access program.
4. The I/O access program denies the writing to the D drive due to the resource access right and the foreignness level of the program S.

### INDUSTRIAL APPLICABILITY

Because the operating system has an immune function by itself, leakage or falsification of information can be prevented.

### EXPLANATION OF LETTERS OR NUMERALS

030 Writing permitted only to the resource having the same foreignness level
111 Reading permitted to all resources
033 Reading and writing permitted to the resource having the same foreignness level and a higher foreignness level

1. A method for giving an immune function (a function for restricting access to system resources) to an operating system having
access rights to the resources
an input source
in process information,
and constituted of foreignness level control information for recognizing said foreignness level of said input source and resource access information for determining access rights to a process resource.
